(19) United States
(12) Patent Application Publication
(10) Pub. No.: US 2002/0085449 A1
(43) Pub. Date: Jul. 4, 2002

(54) Rotary pulsation device

(76) Inventors: Alexander Dmitrievich Fedorov, Kazan (RU); Sergey Germanovich Lebedev, Kazan (RU); Gataullin Rustem Shamgunovich, Kazan (RU); German Alfredovich Volkov, Kazan (RU); Boris Alexandrovich Kesel, Kazan (RU); Dmitry Anatolievich Veselyev, (US)

Correspondence Address: Woodbridge & Associates, P.O. Box 592, Princeton, NJ, 08542, US

(21) Appl. No.: 09/876,511

(22) Filed: Jun. 7, 2001

Related U.S. Application Data
(63) Continuation of application No. 09/284,392, filed on Apr. 13, 1999, now abandoned.

(51) Int. Cl. B01F 7/00

(52) U.S. Cl. 366/304

(57) ABSTRACT

This invention belongs to mixing technology and can be used in the chemical, food, pharmaceutical, and other industries for processes of dispersion, homogenization, pasteurization, and sterilization of liquid media and for performing sonochemical reactions in the ultrasound frequency band. The technical objective is to raise the effectiveness of treatment of flowing liquid media. The technical objective is accomplished by the fact that the rotary pulsation device contains a body (1), rotor (2), and stator (4), having turbulizing elements (3, 8) on their opposing surfaces, and moreover, the disk of the rotor (2) has radial incisions and/or slots (9) between the turbulizing elements 3.

The device is equipped with a means (11) of adjusting the clearance between the rotor (2) and the stator (4), and the stator (4) has at least one support point in the central part, located in the area of the rotor's axis of rotation, and is mounted with a clearance to the body, and the incisions and/or slots on the rotor disk may be located along its periphery or along concentric circles. The turbulizing elements of the rotor and stator are trapezoidal in shape. The central part of the stator has through choke channels (6) to pass the medium and may be made in the form of a conical or cylindrical shell, and the peripheral part [may be made] in the form of a disk or frustum of a cone. The device permits the use of one or more stators with various degrees of stiffness.

This invention belongs to mixing technology and can be used in the chemical, chemical-photographic, food, pharmaceutical, and microbiological industries for processes of dispersion, homogenization, pasteurization, sterilization of liquid media and for performing sonochemical reactions.

The prior art knows a device [1] consisting of a body to whose interior a rotor and stator are mounted, with clearance between the rotor and stator. The rotor and stator have turbulizing elements on their opposing surfaces. The stator is mounted with clearance to the body. The device is equipped with a means of adjusting the clearance between the stator and rotor. The stator is mounted in the body via annular elastic spacers that permit elastic deformation. The prior-art device treats liquids with acoustic vibrations created by the action of the rotor's rotation and the stator's vibration.

The prior art knows a device [2] for ultrasound treatment of liquid media, consisting of a drive shaft and a body with a central inlet tube and outlet tube. Inside the body are slotted rotor and stator, arranged concentrically and mounted on disks, and an ultrasound generator in the form of an ultrasound transformer, fixed via an elastic element in the inlet tube on its axis. On the transformer's surface is a speed converter, whose plane is parallel to that of the rotor disk at a distance dependent on the length of the ultrasound vibrations. The device enables a dispersible medium to be exposed to the additional action of ultrasound vibrations, which intensifies the dispersal process.

The closest analog to the claimed invention is a rotary pulsation device [3] containing a body, within which a stator and a rotor are mounted, with clearance between the stator and the rotor, and turbulizing elements on their opposing surfaces. The stator is mounted with a clearance to the body and has at least one support point in the central part, located in the area of the rotor's axis of rotation. The device is equipped with a means of adjusting the clearance between the rotor and stator. Said design causes the stator, under the action of pulsations in the pressure and speed of the treated medium, to execute forced bulk vibrations over a wide spectrum of acoustic frequencies and induce acoustic vibrations of variable power in the treated medium.

The claimed invention enables treatment of a flowing liquid medium with more effective action of resonant vibrations of the rotor and stator.

Thus, the technical objective of the invention is to raise the effectiveness of treatment of flowing liquid media with regard to expansion of the sphere of application for treatment of flowing liquid media of various types and compositions, specifically, for simultaneous or separate processes of dispersion, homogenization, pasteurization, sterilization, and sonochemical reactions in flowing liquid media using ultrasound resonant vibrations of the rotor and stator.

The technical objective is accomplished by the rotary pulsation device containing a body to whose interior a rotor and stator are mounted with clearance between themselves, and the stator and rotor have turbulizing elements on their opposing surfaces, and moreover, the stator has at least one support point in the central part, located in the area of the rotor's axis of rotation, and is mounted with clearance to the body, said device also containing a means of adjusting the clearance between the rotor and stator, and radial incisions and/or slots are made on the rotor disk between the turbulizing elements. It is the feature of the presence of incisions or slots, as well as that of the new stator mount, that enable the stator and rotor to create ultrasound resonant vibrations, since said incisions and/or slots constitute both additional turbulizing elements and means of affecting the rotor's stiffness, while the stator, mounted at least at one support point, executes bulk resonant vibrations with the rotor. Said ultrasound resonant vibrations of the rotor and stator(s) substantially increase the effectiveness of treatment of flowing liquid media in the claimed rotary pulsation device.

Said treatment both substantially increases the effectiveness of dispersion and homogenization of the treated flowing liquid medium, and increases the effectiveness of pasteurization and sterilization processes, and considerably increases the yield of end products of sonochemical reactions performed under the influence of resonant vibrations of the rotor and stator.

The central part of the stator may be made in the form of a conical or cylindrical shell, and the peripheral part in the form of a disc or frustum of a cone.

In addition, apertures may be made in the conical or cylindrical shell of the central part of the stator.

In addition, the rotary pulsation device may be equipped with at least one additional stator mounted coaxially to the existing stator on the same side of the rotor, and the stators may be made with matching or nonmatching intrinsic frequencies.

The device may be fitted with at least one additional stator mounted on the other side of the rotor.

The stators may be made with various stiffnesses.

To amplify the treatment effect the stator(s) may be mounted with the possibility of varying the clearance relative to the rotor and/or with the possibility of deviation from alignment of the rotor and stator.

Turbulizing elements with either rectangular or trapezoidal cross sections may be mounted on the opposing surfaces of the rotor and stator(s). Turbulizing elements with trapezoidal cross sections permit a substantial increase in the total area of operating clearances between the rotor and stator while preserving the same number of turbulizing elements compared to turbulizing elements with rectangular cross sections.

Through choke channels may be made in the central part of the stator, which enables cyclic treatment of a flowing liquid medium within the device. Moreover, choking of the flowing medium using channels and at the inlet or outlet of the device provides various degrees of cyclicity.

The peripheral part of the stator may be made in the form of a disk or frustum of a cone. Such a design permits it to induce forced bulk vibrations by exerting an acoustic effect on the treated flowing liquid medium.

The mounting of two or more stators on one side of the rotor disk means that each of said stators, possessing individual geometric dimensions, also possesses individual acoustic properties. Each of said stators operates most efficiently in its own frequency range and proves effective in its own stage of dispersion. And since the size of the phase particles is not uniform during dispersion, each group of such particles is most strongly affected by a certain stator with certain geometric characteristics. Thus, the spectrum of frequencies emitted by the stator is expanded.

The fabrication of stators with various stiffnesses, and consequently various intrinsic frequencies, is accomplished by manufacturing them of various materials (metals), various disk or cone wall thicknesses, or various coaxial cylinder thicknesses. As in the previous example, this expands the spectrum of frequencies emitted by the stator, which in turn increases the effectiveness of processes such as dispersion.

Mounting the stator(s) with the possibility of varying the clearance between the rotor and stator and the amount of misalignment of the rotor and stator axes permits the selection, for each specific treated medium, of the optimal distances between the rotor and stator, at which the maximum ultrasound acoustic emissions of the vibration system of stator(s) and rotor are achieved, which in turn permits an increase in effectiveness of treatment of the treated medium by the vibration system of stator(s) and rotor, and in a process such as dispersion, produces particles of the dispersed phase with the smallest possible particle diameter for the given system and/or exerts the maximum sterilizing action on the medium.

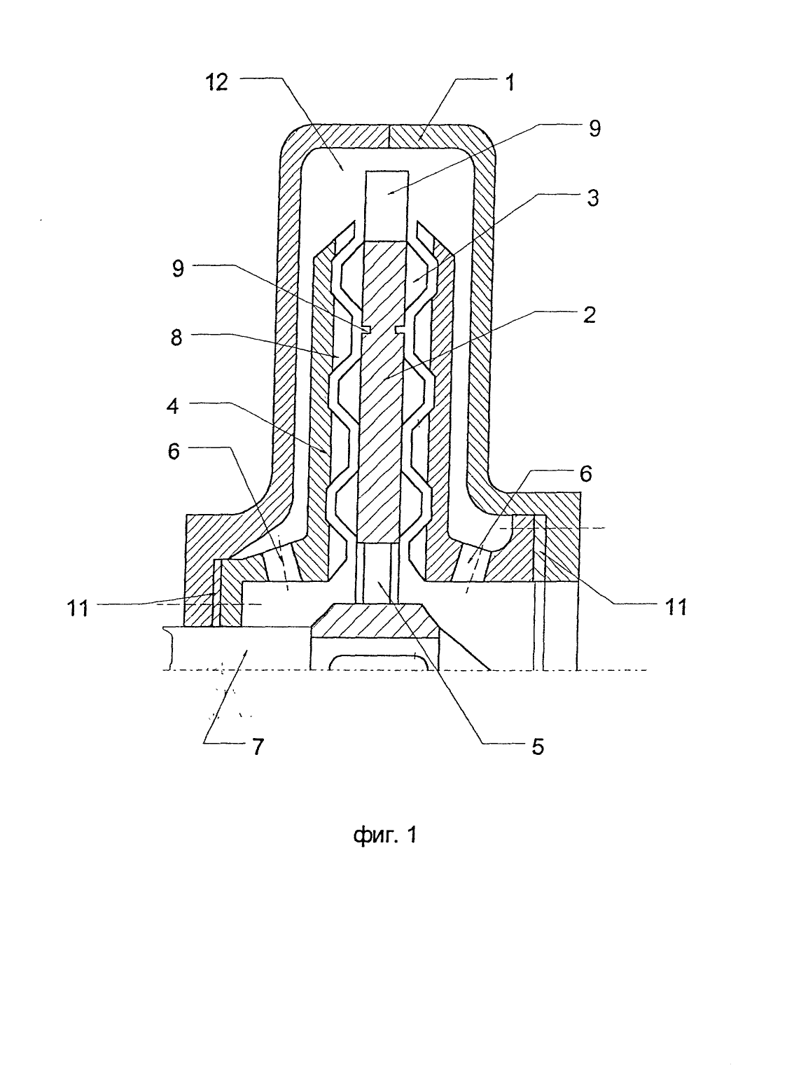

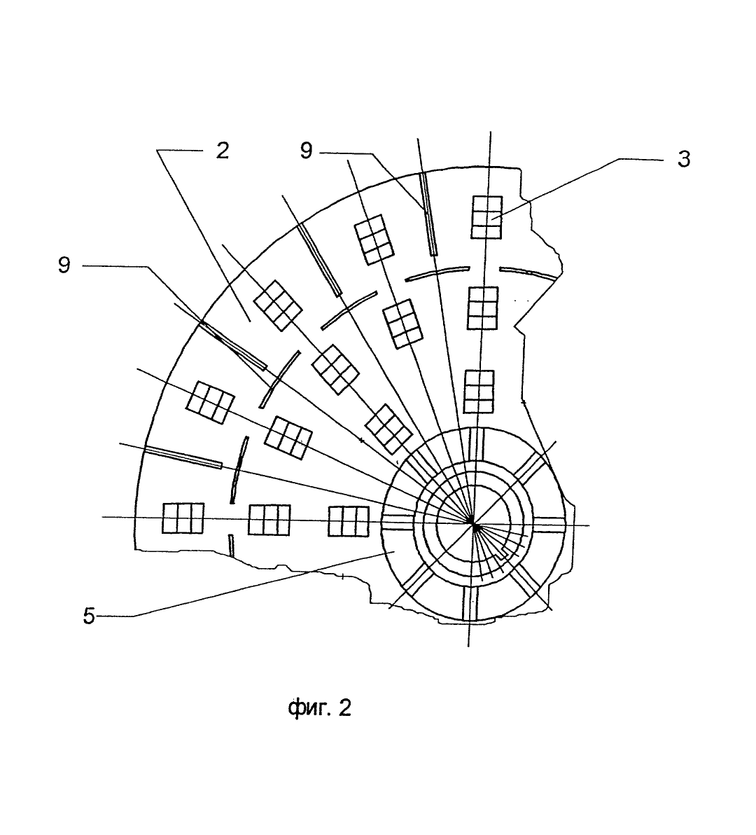

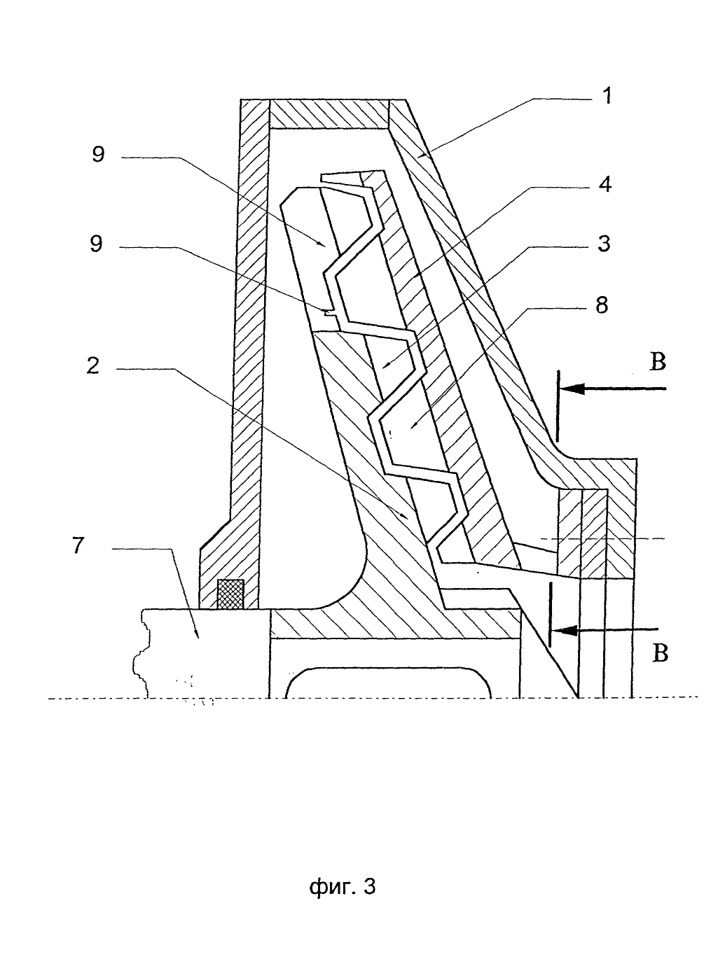

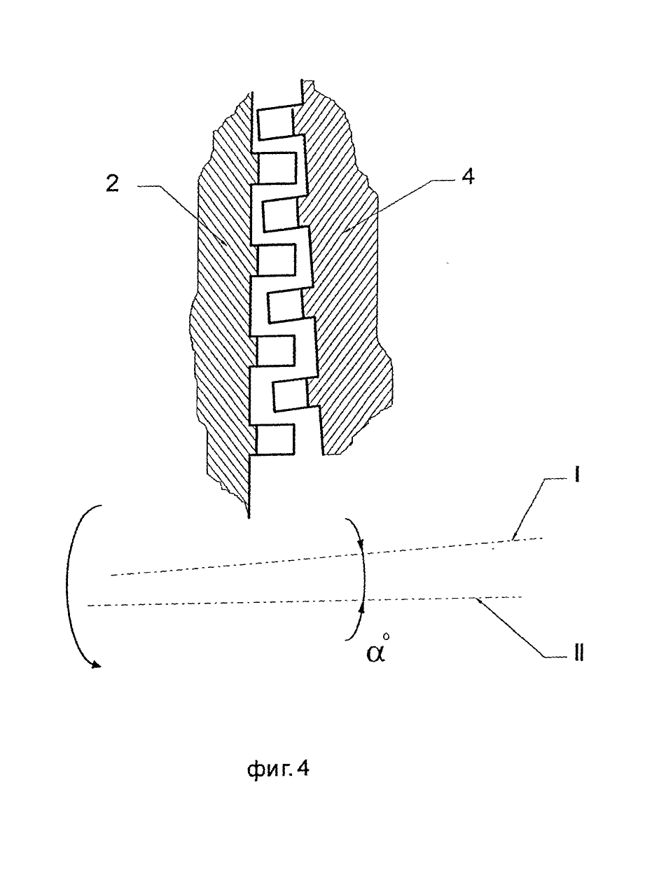

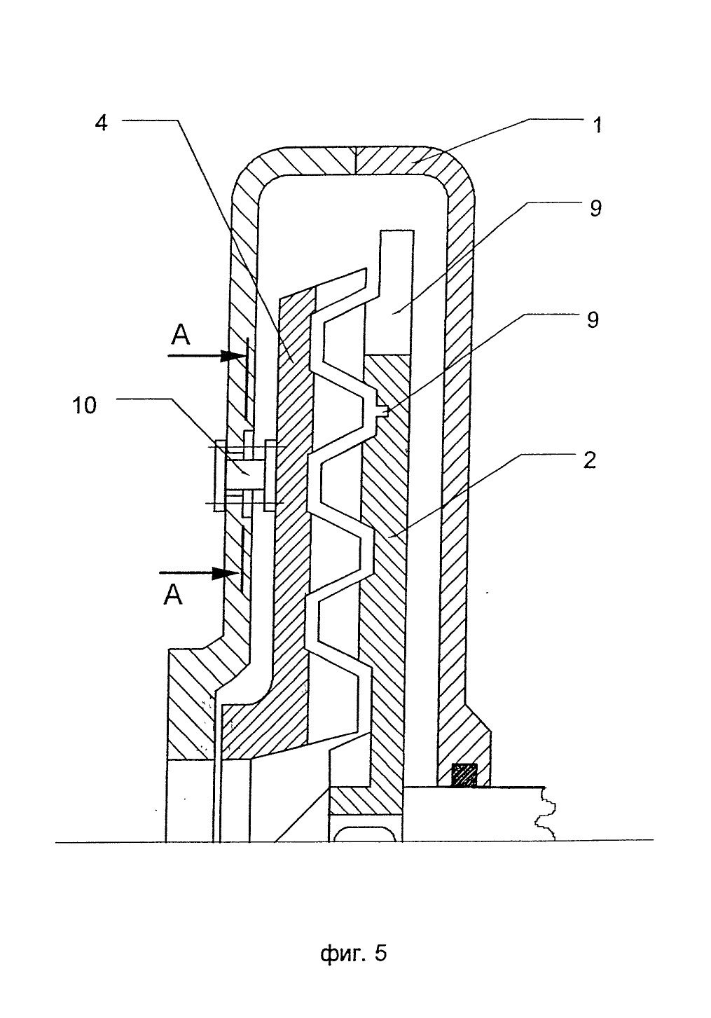

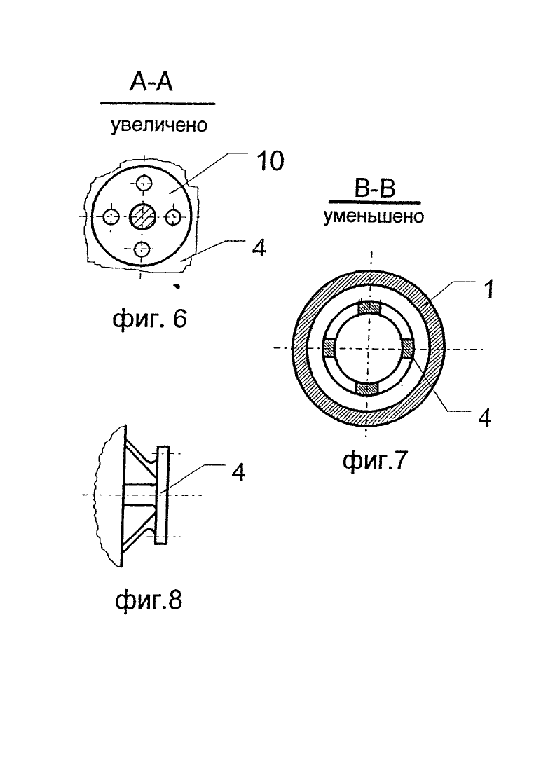

This invention is clarified by figures, where FIG. 1 depicts the longitudinal section of the device, FIG. 2 depicts the design option with trapezoidal turbulizing elements 3 and incisions and/or slots, FIG. 3 depicts the stator and rotor in the form of a frustum of a cone, FIG. 4 depicts the rotor and stator mounted with axial misalignment α, FIG. 5 depicts the fixed-stator design option, FIG. 6 depicts the central part of the stator with mounting assembly (section A-A in FIG. 5), FIG. 7 depicts a stator mounting assembly with apertures, and FIG. 8 depicts the lateral surface of a shell with apertures.

The device (FIG. 1) contains body 1 with inlet and outlet tubes (not shown). Inside the body is mounted a rotor, made in the form of disk 2 with turbulizing elements 3. Between turbulizing elements 3, the rotor has incisions and/or slots 9 (FIG. 2), located on the periphery of the rotor and/or along concentric circles. Disk 2 has apertures 5. Disk 2 is mounted on shaft 7, which is connected to a speed-variable drive, specifically, to an adjustable electric drive (not shown). The central part of stator 4, which has a system of through choke channels 6, is made in the form of a conical shell. Stator 4 has turbulizing elements 8 and is located in body 1 with a clearance such that on each side of disk 2 there may be one, two, or more stators 4. The central part of stator 4 is mounted to body 1 in the area of the rotor's axis of rotation and has at least one support point 10 (FIG. 5). There is a rotor-stator clearance adjustment means 11.

The device operates as follows. The flowing liquid medium enters body 1 through the inlet tube. Rotation is transmitted from the adjustable drive through the shaft to rotor disk 2. Due to centrifugal forces, the turbulizing elements 3 of the rotating rotor disk 2 induce radial movement of the treated medium. The treated flowing liquid medium enter the cavity of the second stator 4, which is mounted on the other side of rotor disk 2, through apertures 5 in disk 2. Moving in the radial gaps between the leading and trailing edges of rotor turbulizing elements 3 and the lateral surfaces of stator turbulizing elements 8, the flowing liquid medium undergoes intense treatment due to the velocity gradient, the pressure gradient, cavitation, and ultrasound acoustic vibrations. The system consisting of the rotor (with incisions and/or slots) and the stator(s) 4, [both] rigidly fixed in the area of the rotor's axis of rotation and mounted in body 1 with a clearance to the latter, begins, under the influence of pressure and velocity pulsations, to execute vibrations relative to body 1 and one another, and these vibrations are bulk vibrations of the surface(s) of stator(s) 4. Said vibrations act on the treated medium, which is both between rotor disk 2 and stator 4 and between stator 4 and body 1. Said effects sharply increase the intensity of processes occurring in the rotary pulsation device. Due to the pressure gradient between the cavity at the inlet to the device and the cavity of inlet scroll 12 at the outlet, the treated flowing liquid medium flows between the body and stator(s) 4, thereby undergoing additional acoustic treatment, and reenters the space between rotor 2 and stator 4 via the system of choke channels 6. Thus, the degree of treatment of the medium can be controlled by varying the pressure gradient between the inlet and outlet cavities, or the system of choke channels. In addition, stagnant zones in the cavities between the stator(s) and the body are eliminated, and active feedback is established, affording high stability in the device's operation.

The ultrasound acoustic effect of the rotor-stator vibration system on the medium is more powerful for the claimed device due to differences in the rotor design and very intense mixing of the treated medium in the zone(s) exposed to the acoustic effect.

A distinguishing feature of the rotor design is the presence of incisions and/or slots between the turbulizing elements located on the rotor's periphery or along concentric circles. The incisions and/or slots permit the production of active rotor elements with various intrinsic vibration frequencies, which expands the spectrum of resonance frequencies of the rotor as a whole.

Active mixing, combined with intense ultrasound acoustic treatment, produces favorable conditions during dispersion of solutions, for example, hydrophobic colorants, during homogenization of milk and milk products, preparation of and ultrafine emulsions and dispersions. The two aforementioned factors also have a favorable effect in pasteurization and sterilization processes, since they permit the entire treated medium to be subjected uniformly to intense acoustic effects that destroy of bacteria and microorganisms.

The adjustable drive permits selection of the rotor speed that produces near-resonant or resonant acoustic vibration frequencies in the body, stator, and rotor. The mounting of two or more stators on one side of the rotor disk, because each has different dimensions (the stator located closer to the rotor axis is smaller than the stator located at a larger diameter), enables each of them to produce its own intrinsic resonance vibration frequency. Stators with smaller dimensions will have higher intrinsic vibration frequencies than stators with larger dimensions. In this case, the device has two or more stators, each of which separately operates most effectively in its own intrinsic rotor speed range. In addition, the incisions and/or slots on the rotor permit production of rotors having various intrinsic vibration frequencies. Thus, the device under discussion, with two or more stators located on one side of the rotor disk, has a rotor-stator system with a wider spectrum of intrinsic vibration frequencies. Making stators with various stiffnesses, i.e., of various materials possessing various moduli of elasticity, and with various disk designs and shapes, also expands the spectrum of intrinsic vibration frequencies of the rotor-stator system, which makes this device more universal and permits its use for treatment of a wide range of various flowing liquid media possessing various physical properties both originally and during treatment (viscosity, interphase surface tension, sound propagation rate in the system, dissipation of acoustic vibrations in the system, etc.). By using the adjustable drive at the acoustic vibration maximum, the most effective rotor speed can be selected, at which, depending on the objective to be accomplished, the most intense dispersion and/or sterilization, and/or mixing, or a combination of these and other processes occurring in the treated media occurs. The mounting of stators on both sides of the rotor disk permits both an increase in process efficiency through increased throughput and an expansion of the range of initial stage of breakaway acoustic cavitation because the stators located on opposite sides of the rotor disk exert a direct effect on one another through the flowing liquid medium being treated. The mounting of a stator or stators in the body with the possibility of varying the distance between them and the rotor and with the possibility of deviation from alignment between them enhances the effect of the rotating rotor on the stator(s). Reducing the clearance (distance) between the rotor and stator, besides amplifying the effect of treatment of the flowing liquid medium, also increases heat released into the liquid and sharply increases the temperature of the treated medium. Therefore, for each specific flowing liquid medium treated, the clearance between the rotor and stator(s) is selected such that the high temperature does not produce changes in the liquid medium with negative consequences. The misalignment between the stator(s) and the rotor disk, on the other hand, intensifies the effect on the part of the rotating rotor on the stator(s), since any amplification or increase in the irregularity of the gap between the rotor and stator amplifies the resulting effect on the part of the rotor on the stator, which in turn intensifies the acoustic processes in the rotor and stator system. This also intensifies the processes occurring in the treated medium. Thus, the claimed device enables considerable intensification of the processes of dispersion, homogenization, mixing, dissolution, and permits sonochemical reactions and/or the aforementioned processes to be performed in combination with high-performance pasteurization or sterilization.

References

1. SU. Author's certificate No. 1479088, class B 01F Jul. 28, 1989.

2. SU. Patent No. 1837953, class B 01F 11/02, published 1993.

3. WO 96/20778 International application No. PCT/RU95/00061, class B 01F 7/00, published Jul. 11, 1996.

1. Rotary pulsation device, containing a body to whose interior a rotor and stator are mounted with clearance between themselves, the stator and rotor having turbulizing elements on their opposing surfaces, and moreover, the stator is mounted with clearance to the body, and has at least one support point in the central part, located in the area of the rotor's axis of rotation, and said device is also equipped with a means of adjusting the clearance between the rotor and stator, characterized in that radial incisions and/or slots are made on the rotor disk between the turbulizing elements to enable the rotor and stator to create ultrasound resonant vibrations.

2. Device per claim 1, characterized in that the incisions and/or slots are located along the periphery of the rotor disk.

3. Device per claims 1 and 2, characterized in that the rotor disk has additional incisions and/or slots located along concentric circles.

4. Device per claim 1, characterized in that the turbulizing elements on the rotor and stator are trapezoidal in shape.

5. Device per claim 1, characterized in that the central part of the stator contains through choke channels.

6. Device per claim 1, characterized in that the central part of the stator, with which it is mounted in the body, is made in the shape of a conical or cylindrical shell, and the peripheral part, mounted with a clearance to the body of the device, is in the shape of a disk or frustum of a cone.

7. Device per claims 1-6, characterized in that the conical or cylindrical shell contains apertures.

8. Device per claims 1-7, characterized in that it is equipped with at least one additional stator mounted coaxially to the existing stator on the same side of the rotor, and the stators are made with matching or nonmatching intrinsic vibration frequencies.

9. Device per claims 1-8, characterized in that it is equipped with at least one additional stator mounted on the other side of the rotor.

10. Device per claims 1-9, characterized in that the stators are made with various stiffnesses.

11.] Device per claims 8-10, characterized in that the additional stators are mounted with the possibility of varying the clearance relative to the rotor and/or with the possibility of deviation from alignment of the rotor and stators.
